(19) United States
(12) Patent Application Publication
(10) Pub. No.: US 2024/0310168 A1
(43) Pub. Date: Sep. 19, 2024

(54) ROAD SURFACE EVALUATION APPARATUS

(71) Applicants: Honda Motor Co., Ltd., Tokyo (JP); Pacific Consultants Co., Ltd., Tokyo (JP)

(72) Inventors: Takeo Tokunaga, Tokyo (JP); Hiroyuki Onimaru, Tokyo (JP); Atsuki Kakinuma, Tokyo (JP); Yasuo Oishi, Tokyo (JP); Akira Iihoshi, Tokyo (JP)

(21) Appl. No.: 18/602,020

(22) Filed: Mar. 12, 2024

(30) Foreign Application Priority Data
Mar. 16, 2023 (JP) 2023-041764

(51) Int. Cl. G01C 7/04; G01C 21/00

(52) U.S. Cl. CPC G01C 7/04; G01C 21/3822

(57) ABSTRACT

A road surface evaluation apparatus includes a microprocessor is configured to perform: calculating a roughness value of road surface corresponding to a predetermined period based on driving information of the plurality of vehicles during the predetermined period; and outputting roughness information including the roughness value. The microprocessor is configured to further perform, when calculating the roughness value corresponding to a second predetermined period, estimating whether a magnitude of a change rate of the roughness value corresponding to the second predetermined period with respect to the roughness value corresponding to a first predetermined period exceeds a predetermined threshold to acquire, when the magnitude is estimated to exceed the predetermined threshold, more pieces of the driving information to be used for calculating the roughness value corresponding to the second predetermined period than when the magnitude is estimated to be equal to or less than the predetermined threshold.

### CROSS-REFERENCE TO RELATED APPLICATION

This application is based upon and claims the benefit of priority from Japanese Patent Application No. 2023-041764 filed on Mar. 16, 2023, the content of which is incorporated herein by reference.

### BACKGROUND OF THE INVENTION

### Field of the Invention

The present invention relates to a road surface evaluation apparatus that evaluates a road surface profile representing unevenness of a road surface.

### Description of the Related Art

As an apparatus of this type, there has been conventionally known an apparatus configured to evaluate road surface roughness based on driving information including driving acceleration and the like acquired from a plurality of vehicles driving on the road (see, for example, WO 2022/059636 A).

However, in the method of evaluating road surface roughness based on the driving information acquired from a plurality of vehicles as in the apparatus described in WO 2022/059636, when the number of vehicles increases, the amount of data may increase and the load on the apparatus and communication infrastructure may increase.

### SUMMARY OF THE INVENTION

An aspect of the present invention is a road surface evaluation apparatus including a microprocessor and a memory connected to the microprocessor. The microprocessor is configured to perform: acquiring driving information of each of a plurality of vehicles, including acceleration information indicating acceleration of each of the plurality of vehicles and map information including information of a road where the plurality of vehicles have driven; calculating a roughness value indicating a roughness of surface of the road corresponding to a predetermined period based on the driving information of the plurality of vehicles driving on the road during the predetermined period; and outputting roughness information including the roughness value in association with the information of the road included in the map information. The microprocessor is configured to perform the acquiring including, in a case where calculating the roughness value corresponding to a second predetermined period after a first predetermined period, estimating whether or not a magnitude of a change rate of the roughness value corresponding to the second predetermined period with respect to the roughness value corresponding to the first predetermined period exceeds a predetermined threshold to acquire, in a case where the magnitude of the change rate is estimated to exceed the predetermined threshold, more pieces of the driving information to be used for calculating the roughness value corresponding to the second predetermined period than in a case where the magnitude of the change rate is estimated to be equal to or less than the predetermined threshold.

### BRIEF DESCRIPTION OF THE DRAWINGS

The objects, features, and advantages of the present invention will become clearer from the following description of embodiments in relation to the attached drawings, in which:

FIG. 1 is a diagram showing an example of the configuration of a road surface evaluation system including a road surface evaluation apparatus according to an embodiment of the present invention;

FIG. 2 is a block diagram illustrating key components of an in-vehicle terminal according to the embodiment of the present invention;

FIG. 3 is a block diagram illustrating key components of a driving information storage apparatus according to the embodiment of the present invention;

FIG. 4 is a block diagram illustrating key components of the road surface evaluation apparatus according to the embodiment of the present invention;

FIG. 5 is a diagram showing an example of a map of a road on which vehicles are traveling;

FIG. 6 is a diagram showing an example of driving information;

FIG. 7 is a diagram showing an example of composite driving information;

FIG. 8A is a diagram illustrating how to derive correlation between road surface roughness values and lateral acceleration;

FIG. 8B is a diagram illustrating how to derive the correlation between the road surface roughness values and the lateral acceleration;

FIG. 9A is a diagram showing an example of road surface profile information;

FIG. 9B is a diagram showing another example of road surface profile information;

FIG. 9C is a diagram showing another example of road surface profile information;

FIG. 10A is a diagram for illustrating change in road surface roughness at the point A in FIG. 9A;

FIG. 10B is a diagram for illustrating the change in road surface roughness at the point A in FIG. 9A; and

FIG. 11 is a flowchart illustrating an example of processing executed by the processing unit in FIG. 3.

### DETAILED DESCRIPTION OF THE INVENTION

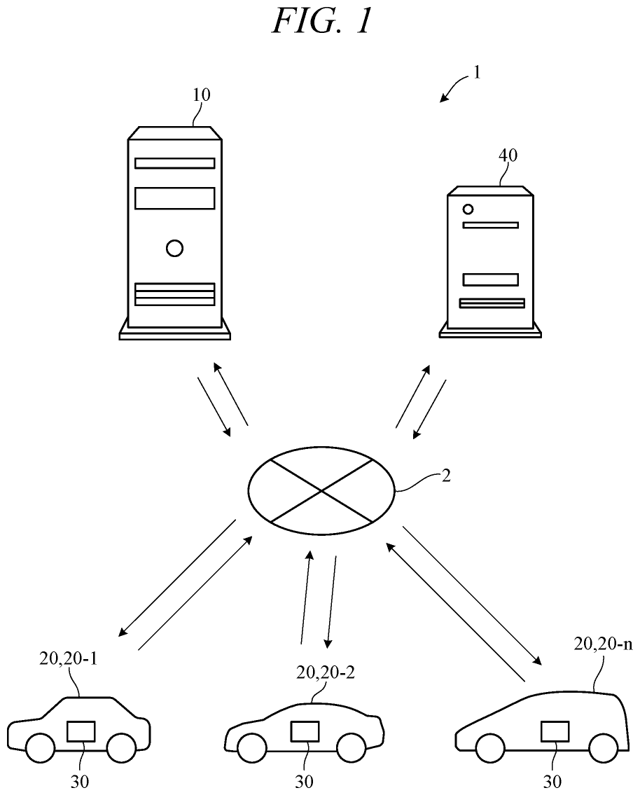

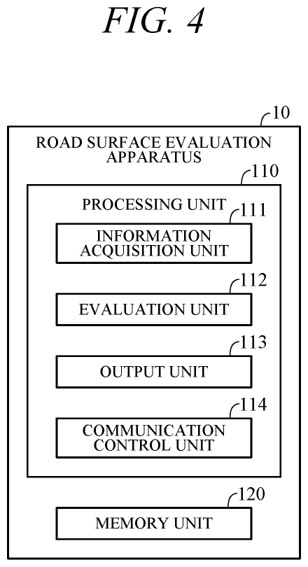

A description will be given below of an embodiment of the present invention with reference to FIGS. 1 to 11. The road surface evaluation apparatus according to the present embodiment is a device for evaluating the road surface profile of a road on which vehicles are traveling. FIG. 1 illustrates an example of the configuration of a road surface evaluation system including a road surface evaluation apparatus according to the present embodiment. As illustrated in FIG. 1, the road surface evaluation system 1 includes a road surface evaluation apparatus 10, an in-vehicle terminals 30, and a driving information storage apparatus (hereinafter referred to as simply a storage apparatus) 40. The road surface evaluation apparatus 10 and storage apparatus 40 each include, for example, a server device. The in-vehicle terminals 30 are configured to communicate with the road surface evaluation apparatus 10 and storage apparatus 40 via a communication network 2.

The communication network 2 includes not only public wireless communication networks represented by Internet networks and cell phone networks, but also closed communication networks established for each predetermined administrative region, such as wireless LAN, Wi-Fi (registered trademark), and Bluetooth (registered trademark).

The in-vehicle terminals 30 are mounted on vehicles 20. The vehicles 20 include a plurality of vehicles 20-1, 20-2, . . . , and 20-n. The vehicles 20 may be manual driving vehicles or self-driving vehicles. The vehicles 20 may include vehicles of different models and grades.

FIG. 2 is a block diagram illustrating the key components of the in-vehicle terminal 30 according to the present embodiment. The in-vehicle terminal 30 includes an electronic control unit (ECU) 31, a position measurement sensor 32, an acceleration sensor 33, a steering angle sensor 34, a vehicle speed sensor 35, and a telematic control unit (TCU) 36.

The position measurement sensor 32 is, for example, a GPS sensor, which receives positioning signals transmitted from GPS satellites and detects the absolute position (e.g., latitude and longitude) of the vehicle 20. The position measurement sensor 32 includes not only GPS sensors but also sensors that use radio waves transmitted from satellites in various countries, known as GNSS satellites, including quasi-zenith orbit satellites.

The acceleration sensor 33 detects the acceleration of the vehicle 20 in the left-right directions, that is, lateral acceleration. The acceleration sensor 33 may be configured to detect acceleration in the front-back direction and vertical direction as well as lateral acceleration of the vehicle 20. The steering angle sensor 34 detects the steering angle of the steering wheel (not illustrated) of the vehicle 20. The vehicle speed sensor 35 detects the vehicle speed of the vehicle 20.

As illustrated in FIG. 2, the ECU 31 includes a computer including a processing unit 310 such as a CPU, a memory unit 320 such as ROM and RAM, and other peripheral circuits such as I/O interfaces not illustrated. The processing unit 310 functions as a sensor value acquisition unit 311 and a communication control unit 312 by executing a program stored in the memory unit 320 in advance.

The sensor value acquisition unit 311 acquires the detected values of the sensors 33 to 35 and the absolute position of the vehicle 20 detected by the position measurement sensor 32 at a predetermined sampling period. The communication control unit 312 transmits the information acquired by the sensor value acquisition unit 311 (hereinafter referred to as driving information) to the communication network 2 at a predetermined period via the TCU 36, together with the vehicle ID that can identify the vehicle 20.

The road surface evaluation apparatus 10 detects the unevenness of the road surface, that is, the road surface roughness (hereinafter also referred to as a road surface profile), based on the detected values of the acceleration sensors 33 of the vehicles 20 (in-vehicle terminals 30). The detected road surface profile information is output to, for example, a terminal owned by a road management company or the like, and is used as reference data by the road management company when considering whether or not repairs are necessary. Specifically, the detected values of the acceleration sensor are used to evaluate the road surface profile.

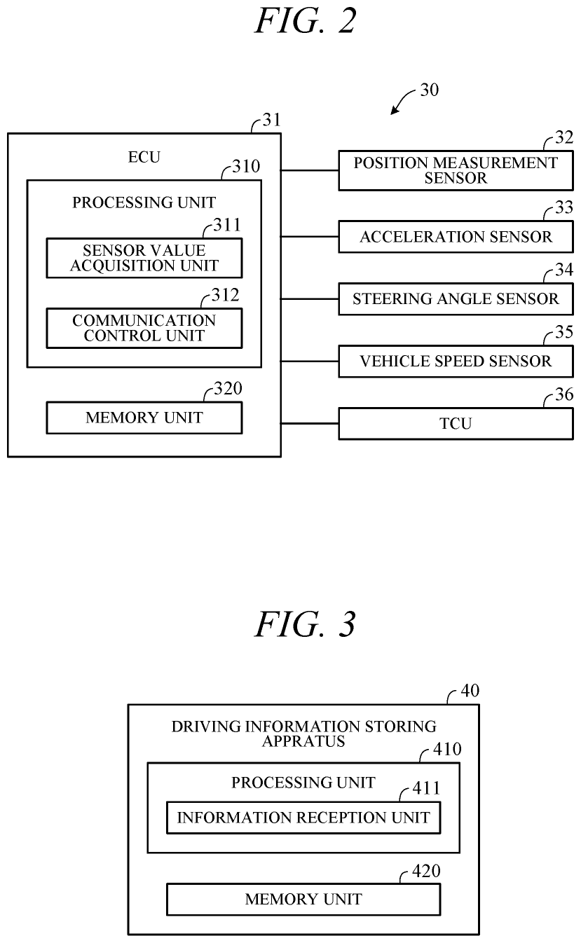

FIG. 3 is a block diagram illustrating a configuration of main components of the memory device 40 according to the present embodiment. The memory device 40 is configured to include a computer including a processing unit 410, such as a CPU, a memory unit 420 such as ROM and RAM, and other peripheral circuits such as I/O interfaces not illustrated. The processing unit 410 functions as an information reception unit 411 by executing a program stored in the memory unit 420.

The information reception unit 411 receives driving information transmitted from the in-vehicle terminals 30 of the vehicles 20 driving on the road. The driving information includes position information indicating the position of the vehicle 20, driving time information indicating the time when the vehicle 20 has driven the position, and acceleration information indicating the acceleration of the vehicle 20. The acceleration information includes information on the lateral acceleration of the vehicle 20 detected by the acceleration sensor 33. In addition, the driving information includes driving speed information indicating the driving speed of the vehicle 20. The driving speed information indicates the sensor value of the vehicle speed sensor 35, that is, the measured driving speed of the vehicle 20. Further, the driving information includes steering angle information indicating the steering angle of the steering wheel of the vehicle 20. The steering angle information indicates the sensor value of the steering angle sensor 34, that is, the measured steering angle of the vehicle 20. The steering angle information may be configured to use information acquired by a yaw rate sensor (not shown) installed in the vehicle 20 (hereinafter referred to as yaw rate sensor information). Note that the vehicle ID associated with the driving information can identify the vehicle 20 from which the driving information was transmitted.

The information reception unit 411 stores driving information received from the plurality of vehicles 20 (in-vehicle terminals 30) in the memory unit 120 in time series. Hereafter, the driving information stored in time series in the memory unit 120 is referred to as time-series driving information.

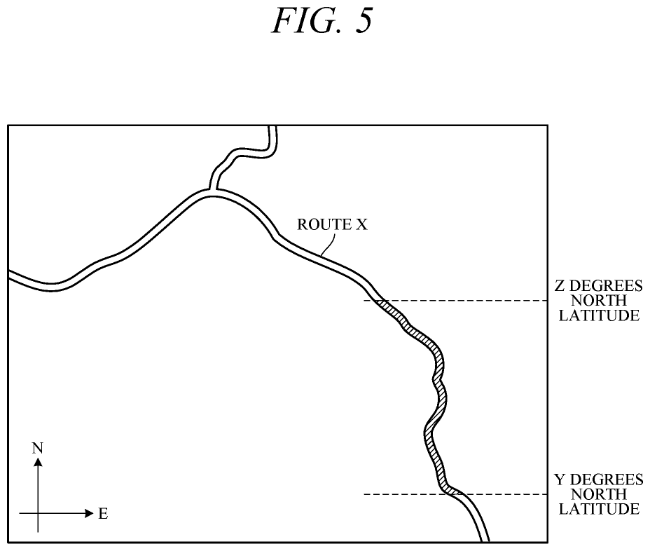

FIG. 5 is a block diagram illustrating the key components of the road surface evaluation apparatus 10 according to the present embodiment. The road surface evaluation apparatus 10 is configured to include a computer including a processing unit 110, such as a CPU, a memory unit 120 such as ROM and RAM, and other peripheral circuits such as I/O interfaces not illustrated. The memory unit 120 stores map information including road maps, and various information processed by the processing unit 110.

The processing unit 110 functions as an information acquisition unit 111, an evaluation unit 112, an output unit 113, and a communication control unit 114 by executing programs stored in the memory unit 120.

The information acquisition unit 111 acquires, from the memory device 40, driving information of the plurality of vehicles 20 corresponding to the evaluation period and the road to be evaluated for road surface roughness (hereinafter referred to as the evaluation period and the road to be evaluated, respectively). The evaluation period and the road to be evaluated are designated by an instruction to output the road surface profile to be described later. FIG. 5 illustrates an example of a map of the road on which the vehicles 20 are driving. In FIG. 5, the sections (the latitude Y to Z of National Route X) designated as the road to be evaluated are shaded. In FIG. 5, the upper direction corresponds to the north direction, and the right direction corresponds to the east direction. In a case where the road to be evaluated has a plurality of lanes on each side, the lane to be evaluated for road surface roughness may be designated by the user. The information acquisition unit 111 acquires map information including information on the road to be evaluated from the memory unit 120.

The evaluation unit 112 evaluates the amount of unevenness (depth or height) of the road surface, or road surface roughness of the road to be evaluated, based on the driving information of the plurality of vehicles 20 corresponding to the evaluation period and the road to be evaluated acquired by the information acquisition unit 111. More specifically, the evaluation unit 112 calculates the road surface roughness value indicating the degree of road surface roughness based on the lateral accelerations of the plurality of vehicles 20 corresponding to the evaluation period acquired by the information acquisition unit 111. The road surface roughness values are, for example, values expressed in terms of the International Roughness Index (IRI), which is an international index. Hereinafter, the road surface roughness values may be simply referred to as roughness values.

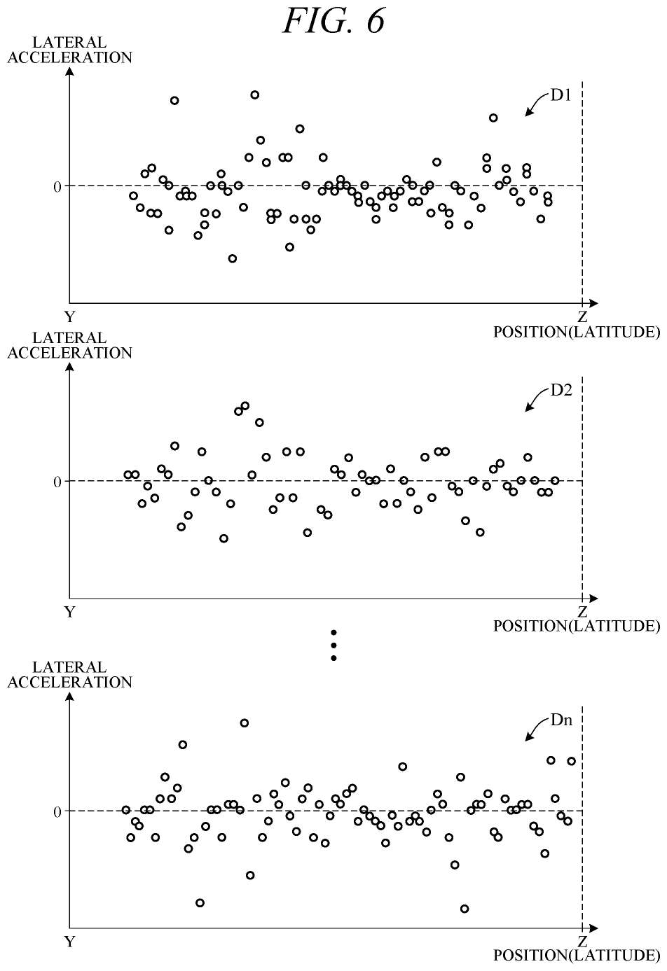

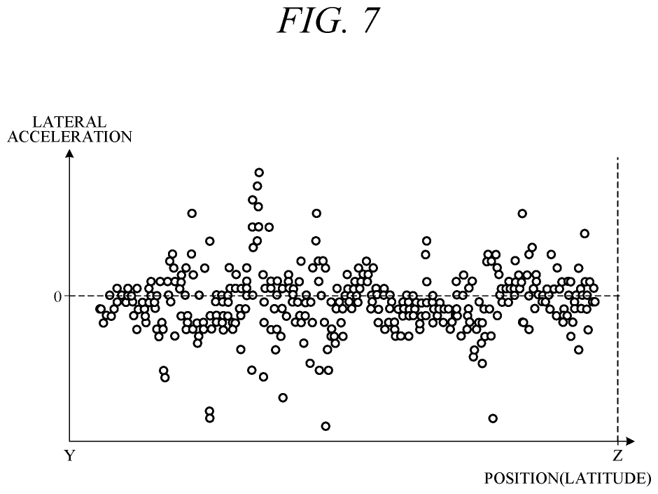

FIG. 6 illustrates an example of time-series driving information obtained by the road surface evaluation apparatus 10 from the in-vehicle terminal 30 of the vehicle 20 traveling in the road to be evaluated (latitude Y to Z on National Route X) in FIG. 5. The horizontal axis in the figure is the position (latitude) of the vehicles 20 in the traveling direction along the traveling lane, and the vertical axis is the lateral acceleration of the vehicles 20. Characteristics D1, D2, . . . , Dn represent the time-series driving information of the vehicles 20-1, 20-2, . . . , 20-n, respectively. Increasing the above sampling period improves the accuracy of the road surface roughness value calculated by the evaluation unit 112, allowing accurate evaluation of the road surface profile. However, a high sampling period (for example, 100 Hz) of driving information increases the processing load of the in-vehicle terminal 30. Furthermore, it increases the data volume of driving information transmitted to the road surface evaluation apparatus 10, which may put pressure on the bandwidth of the communication network 2. In consideration of this point, the evaluation unit 112, combines driving information sampled at the first sampling period (e.g., 1 Hz) transmitted from n vehicles 20 to generate composite driving information whose sampling period is the second sampling period (1×n Hz), and calculates the road surface roughness value based on the composite driving information. Here, generation of the composite driving information will be described with reference to FIG. 7.

FIG. 7 illustrates an example of composite driving information generated based on driving information acquired from the in-vehicle terminals 30 of the plurality of vehicles 20 traveling on the road in FIG. 5. The composite driving information is the information of the acceleration information of the vehicles 20 combined based on the position information of the vehicles 20. The composite driving information illustrated in FIG. 7 is acquired by superimposing the values of the vertical axis (lateral acceleration) for the vehicles 20 illustrated in FIG. 6 with reference to the horizontal axis (latitude). Since the vehicle speeds of the vehicles 20 and the points at which the vehicles 20 start sampling are different, the timing at which the driving information is sampled is considered to be different for each of the vehicles 20, even if the sampling period of the driving information for the vehicles 20 is the same. Therefore, by combining the driving information sampled at 1 Hz in n vehicles 20 as described above, driving information whose sampling period is equivalent to 1×n Hz is acquired. The evaluation unit 112 evaluates the surface roughness of the road on which the vehicles 20 are traveling based on the composite driving information acquired in this manner.

In general, the greater the amount of unevenness of the road surface, the greater the lateral acceleration of the vehicle 20, and the road surface roughness value and lateral acceleration have a certain correlation. The evaluation unit 112 uses information indicating this correlation (hereafter referred to as correlation data) to calculate a road surface roughness value corresponding to the vehicle position on the road from the lateral acceleration.

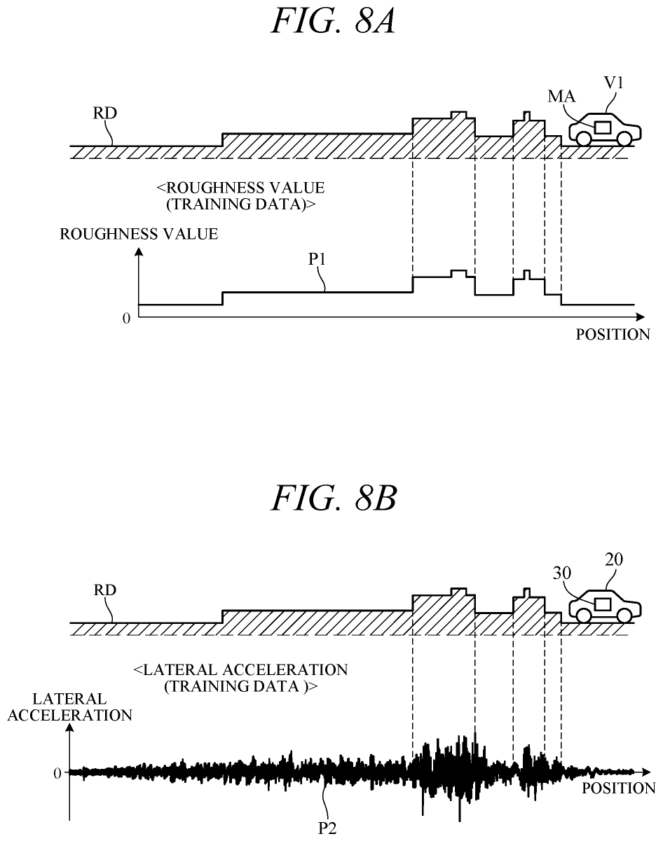

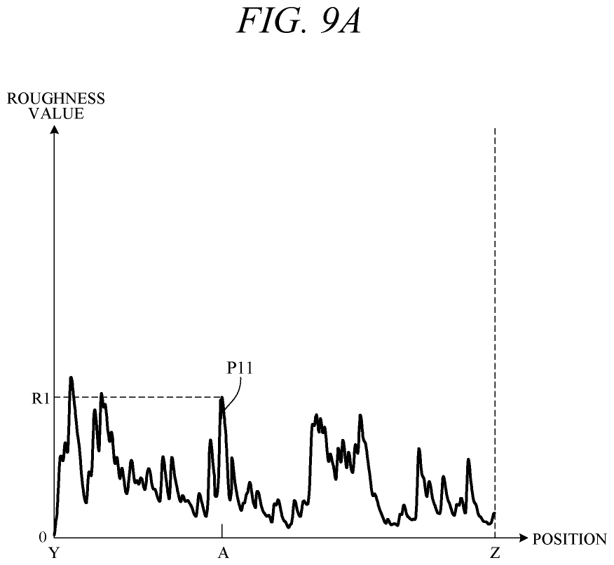

First, the evaluation unit 112 performs machine learning using pre-measured road surface roughness values and lateral acceleration as training data to calculate the correlation between road surface roughness values and lateral acceleration. FIGS. 8A and 8B illustrate the training data for road surface roughness values and lateral acceleration, respectively. A vehicle V1 illustrated in FIG. 8A is a dedicated vehicle including a measuring instrument MA that measures road surface roughness. The measuring instrument MA measures the road surface roughness values of the road RD when the vehicle V1 is traveling on a predetermined road (such as a course for measurement) RD. A characteristic P1 in FIG. 8A represents the road surface roughness value measured at this time, that is, the road surface roughness value used as the training data.

FIG. 8B illustrates the vehicles 20 in FIG. 1 traveling on the same road RD as that in FIG. 8A. A characteristic P2 in FIG. 8B represents the lateral acceleration detected by the acceleration sensors 33 installed in the vehicles 20 while the vehicles 20 are traveling on a predetermined road RD, that is, the lateral acceleration used as the training data.

The training data for road surface roughness values and lateral acceleration may be stored in the memory unit 120 of the road surface evaluation apparatus 10 or in an external storage device. The evaluation unit 112 performs machine learning using training data of the road surface roughness values and lateral acceleration read from the memory unit 120 or an external storage device to calculate the correlation between the road surface roughness values and lateral acceleration. The traveling speed, front/rear acceleration, and steering angle may be added as training data for machine learning.

The evaluation unit 112 calculates road surface roughness values for the road to be evaluated based on the correlation between the calculated road surface roughness values and lateral acceleration and the composite driving information corresponding to the road to be evaluated.

The output unit 113 outputs the road surface roughness information evaluated by the evaluation unit 112, that is, the road surface roughness values, in association with the road information acquired by the information acquisition unit 111. The information output at this time is referred to as road surface profile information. When the output unit 113 receives an instruction to output the road surface profile from a terminal of a road management company or the like via the communication network 2, it outputs the road surface profile information to the terminal from which the output instruction was transmitted or to a predetermined output destination terminal. The instruction to output the road surface profile may be input to the road surface evaluation apparatus 10 via an operation unit (not illustrated) included in the road surface evaluation apparatus 10. The road surface profile information is information that can be displayed on a display device such as a display, and the user (for example, a road management company) can check the road surface profile by displaying the road surface profile information on the display included in the user's terminal. The output unit 113 may output the road surface profile information to the memory unit 120. For example, the road surface profile information may be output so as to be mapped on the map information stored in the memory unit 120.

By the way, when the number of vehicles 20 increases, the data amount of the driving information increases, which may put pressure on the memory area of the memory device 40 (memory unit 420) and the band of the communication network 2. On the other hand, sections where no major road surface changes due to depression or the like are assumed to have occurred do not require prompt action (repair of the road or the like), so there is no need to present detailed evaluation result of the road surface roughness to the user. In consideration of this point, the evaluation unit 112 evaluates the road surface roughness as follows.

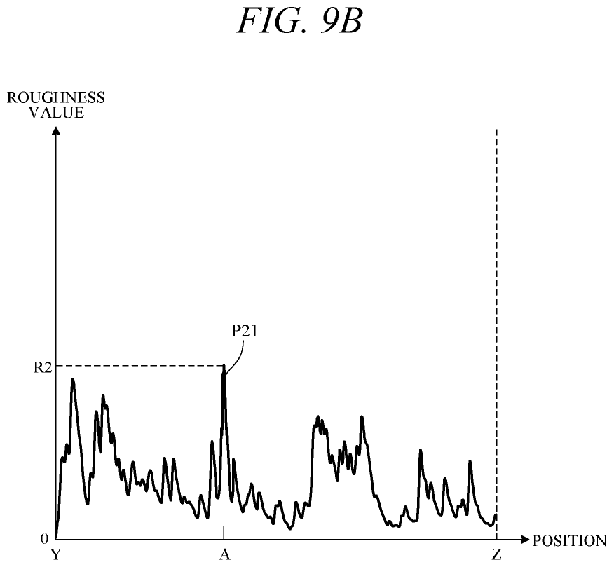

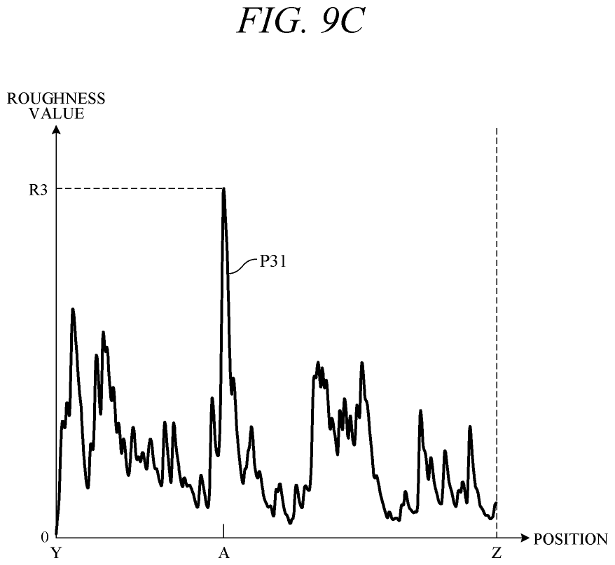

FIGS. 9A, 9B, and 9C illustrate an example of road surface profile information generated based on driving information acquired from the plurality of vehicles 20 driving on the road to be evaluated (latitudes Y to Z on National Route X). The horizontal axis indicates the position (latitude) of the vehicles 20 in the driving direction along the traveling lane, and the vertical axis indicates the road surface roughness values.

FIG. 9A illustrates the road surface profile information generated based on the driving information acquired during the predetermined period T1. A characteristic P11 in the figure represents the road surface roughness value calculated based on the composite driving information acquired by combining the pieces of driving information of the plurality of vehicles 20 acquired during the predetermined period T1. FIG. 9B illustrates the road surface profile information generated based on driving information acquired during the predetermined period T2 after the predetermined period T1. A characteristic P21 in the figure represents the road surface roughness value calculated based on the composite driving information acquired by combining the pieces of driving information of the plurality of vehicles 20 acquired during the predetermined period T2. FIG. 9C illustrates the road surface profile information generated based on the driving information acquired during the predetermined period T3 after the predetermined period T2. A characteristic P31 in the figure represents the road surface roughness value calculated based on the composite driving information acquired by combining the pieces of driving information of the plurality of vehicles 20 acquired during the predetermined period T3. The road surface roughness values R1, R2 (>R1), and R3 (>R2) represent the road surface roughness at the point A in the predetermined periods T1, T2, and T3, respectively.

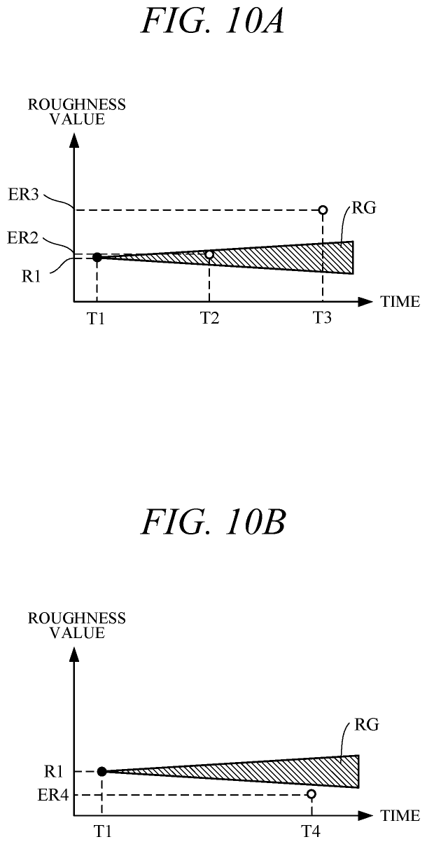

FIGS. 10A and 10B are diagrams for illustrating the change in road surface roughness at the point A. The horizontal axis represents time, and the vertical axis represents the road surface roughness value. The black circle in FIG. 10A represents the road surface roughness value R1 at the point A calculated based on the composite driving information corresponding to predetermined period T1.

When the evaluation unit 112 calculates the road surface roughness value R2 at the point A in the predetermined period T2, it first estimates the road surface roughness value at the point A in the predetermined period T2. The road surface roughness value estimated at this time is referred to as an estimated roughness value. The white circles in FIG. 10A represent estimated roughness values. The evaluation unit 112 acquires the road surface roughness value at the point A calculated using the composite driving information corresponding to the predetermined period T2 as the estimated roughness value ER2. Next, the evaluation unit 112 determines whether or not the magnitude (absolute value) of the change rate of the estimated roughness value ER2 with respect to the road surface roughness value R1 (hereinafter referred to as a roughness value change rate or simply a change rate) exceeds a predetermined threshold. The shaded region RG in FIG. 10A represents the range of the road surface roughness value in which the magnitude of the change rate with respect to the road surface roughness value R1 is equal to or less than a predetermined threshold. As illustrated in FIG. 10A, the longer the elapsed time from the predetermined period T1, the larger the value is set for the predetermined threshold. Note that the predetermined period T1 used as a reference when calculating the change rate is referred to as a reference predetermined period.

In the example illustrated in FIG. 10A, since the estimated roughness value ER2 is included in the region RG, the evaluation unit 112 determines that the magnitude of the change rate of the estimated roughness value ER2 with respect to the road surface roughness value R1 is equal to or less than the predetermined threshold, and calculates the estimated roughness value ER2 as the road surface roughness value R2 at the point A as it is.

Similarly, when the evaluation unit 112 calculates the road surface roughness value R3 at the point A in the predetermined period T3, it first estimates the road surface roughness value at the point A in the predetermined period T3. That is, the estimated roughness value ER3 at the point A corresponding to the predetermined period T3 is calculated. Then, it is determined whether or not the magnitude of the change rate of the estimated roughness value ER3 with respect to the road surface roughness value R1 exceeds a predetermined threshold. In the example illustrated in FIG. 10A, since the estimated roughness value ER3 at the point A corresponding to the predetermined period T3 is outside the region RG, the evaluation unit 112 determines that the magnitude of the change rate exceeds the predetermined threshold.

When the magnitude of the change rate exceeds the predetermined threshold, it is assumed that the uneven shape of the road surface has suddenly changed, and thus a road management company or the like must take measures such as road repair. Therefore, it is preferable that sudden changes in the uneven shape of the road surface be detected with higher accuracy. Therefore, when the evaluation unit 112 determines that the magnitude of the change rate exceeds the predetermined threshold, it increases the driving information used for calculating the roughness value so as to improve the evaluation accuracy of the road surface roughness compared to when it determines that the magnitude of the change rate is equal to or less than the predetermined threshold. Specifically, the evaluation unit 112 changes the start point or the end point of the predetermined period T3 to extend the length of the predetermined period T3. As a result, the driving information of the vehicle 20 corresponding to the period extended by the evaluation unit 112 is additionally acquired from the memory device 40 by the information acquisition unit 111. The evaluation unit 112 calculates the road surface roughness value R3 at the point A in the predetermined period T3 using the driving information additionally acquired by the information acquisition unit 111 in addition to the driving information used for calculating the estimated roughness value ER3.

FIG. 10B illustrates the estimated roughness value ER4 at the point A in the predetermined period T4 after the predetermined period T1. As in the example illustrated in FIG. 10B, even when the magnitude of the change rate of the estimated roughness value ER4 with respect to the road surface roughness value R1 exceeds the predetermined threshold, when the estimated roughness value ER4 is below the region RG, that is, when the change rate is a negative value, it can be estimated that the road surface roughness has improved due to road repair or the like. In this case, the evaluation unit 112 does not additionally acquire the driving information. In addition, the evaluation unit 112 deletes the driving information corresponding to the point A stored in the memory device 40 (memory unit 420). At this time, the driving information corresponding to at least the predetermined period T1 (reference predetermined period) is deleted. When the change rate is a negative value regardless of the magnitude of the change rate, that is, when the estimated roughness value ER4 is smaller than the road surface roughness value R1, the evaluation unit 112 may estimate that the road surface roughness has improved due to road repair or the like, and may not additionally acquire the driving information. In addition, the driving information corresponding to the point A stored in the memory device 40 may be deleted.

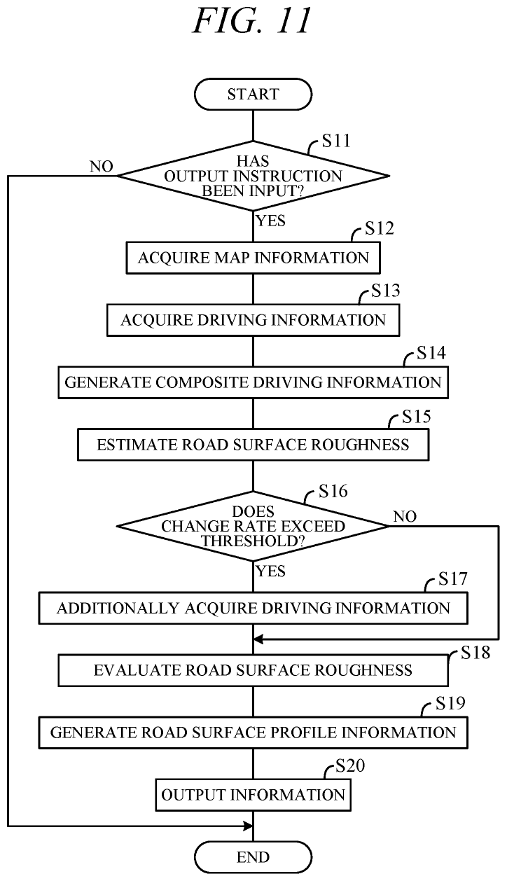

FIG. 11 is a flowchart illustrating an example of processing executed by the processing unit 110 (CPU) of the road surface evaluation apparatus 10 according to a predetermined program. The processing illustrated in this flowchart is repeated at a predetermined cycle while the road surface evaluation apparatus 10 is running. First, in step S11, it is determined whether or not an instruction to output the road surface profile has been input (received).

The instruction to output the road surface profile includes section information that can identify the road to be evaluated. The section information includes information that indicates the name and range of the section of the road to be evaluated, for example, “road: National Route X, section: latitude Y to Z”. When the road has a plurality of lanes on each side, such as two lanes on one side, the section information may include information on the lane to be evaluated, such as “road: National Route X, lane: right end, section: latitude Y to Z”. Information other than latitude may be used to specify the road to be evaluated. For example, longitude may be used instead of latitude or in addition to latitude. Alternatively, the distance from the start point of the section may be used. The instruction to output the road surface profile further includes period information designating the evaluation period. The period information includes information indicating the evaluation period, for example, “one month from X month Y day”. The period information also includes information designating the reference predetermined period. As the reference predetermined period, a predetermined period that was used as an evaluation period in the past is designated.

If NO in step S11, the processing ends. If YES in step S11, in step S12, map information is read from the memory unit 120, and road information included in the map information is acquired. In step S13, driving information of the vehicle 20 is acquired from the memory unit 120. More specifically, based on the section information and period information included in the instruction to output the road surface profile and the road information acquired in step S12, the driving information corresponding to the road to be evaluated identified based on the section information and corresponding to the evaluation period designated by the period information is read from the memory unit 120. At this time, when there is a plurality of vehicles 20 that have driven on the road to be evaluated, driving information corresponding to each of the plurality of vehicles 20 is acquired. When the section information included in the instruction to output the road surface profile includes information on the lane to be evaluated, driving information including position information corresponding to the lane is read from the memory unit 120.

In step S14, composite driving information is generated based on the driving information read from the memory unit 120 in step S13. In step S15, the road surface roughness is estimated based on the composite driving information generated in step S14. More specifically, the road surface roughness value is calculated based on the composite driving information generated in step S14, and the road surface roughness value is acquired as the estimated roughness value. In step S16, it is determined whether or not there is a point on the road to be evaluated where the magnitude of the change rate of the estimated roughness value with respect to the road surface roughness value corresponding to the reference predetermined period exceeds the predetermined threshold (hereinafter may be referred to as a road surface change point). If NO in step S16, the processing proceeds to step S18. When YES in step S16, in step S17, the driving information corresponding to the point where the magnitude of the change rate exceeds the predetermined threshold is acquired more than that of the point where the magnitude of the change rate is equal to or less than the predetermined threshold. Specifically, the driving information of the vehicle 20 corresponding to the extended evaluation period and corresponding to the point where the magnitude of the change rate exceeds the predetermined threshold is additionally acquired from the memory device 40. Then, composite driving information is generated based on the driving information read from the memory unit 120 in step S13 and the additionally acquired driving information.

In step S18, the road surface roughness is evaluated. Specifically, in step S18 executed after NO in step S16, the estimated roughness value acquired in step S15 is directly used to evaluate the road surface roughness. On the other hand, in step S18 executed after step S17, the road surface roughness value is calculated based on the composite driving information generated in step S17.

In step S19, information in which the road surface roughness value calculated in step S18 is associated with the road information acquired in step S12, that is, road surface profile information is generated. In step S20, the road surface profile information generated in step S19 is output. As a result, the road surface profile information can be displayed on a display device such as a display, which allows the user to check the road surface profile information. When the evaluation period is extended in step S17, the road surface profile information may include information (text information or the like) indicating that the evaluation period has been extended and the extended evaluation period. In addition, the road surface profile information may include information indicating the point where the magnitude of the change rate is equal to or greater than the predetermined threshold, for example, display information such that the road surface roughness value corresponding to the point is displayed in a different color from the road surface roughness values corresponding to other points.

According to the embodiment of the present invention, the following effects can be achieved.

(1) The road surface evaluation apparatus 10 includes: an information acquisition unit 111 configured to acquire driving information of each of a plurality of vehicles 20, including acceleration information indicating the acceleration of the plurality of vehicles 20, and map information including information on roads on which the plurality of vehicles 20 have driven; and an output unit 113 configured to calculate the roughness value indicating the road surface roughness corresponding to the predetermined period based on the driving information of the plurality of vehicles 20 that have driven on the road during the predetermined period acquired by the information acquisition unit 111, and output the roughness information including the calculated roughness value in association with the road information acquired by the information acquisition unit 111. When the evaluation unit 112 calculates the roughness value corresponding to the second predetermined period (predetermined periods T2, T3, and T4) after the first predetermined period (reference predetermined period T1), the information acquisition unit 111 estimates whether or not the magnitude of the change rate of the roughness value corresponding to the second predetermined period with respect to the roughness value corresponding to the first predetermined period calculated by the evaluation unit 112 exceeds a predetermined threshold. When the information acquisition unit 111 estimates that the magnitude of the change rate exceeds the predetermined threshold, it acquires more pieces of driving information to be used for calculating the roughness value corresponding to the second predetermined period than when it estimates that the magnitude of the change rate is equal to or less than the predetermined threshold. When the information acquisition unit 111 estimates that the magnitude of the change rate exceeds the predetermined threshold, it changes the start point or the end point of the second predetermined period to extend the second predetermined period, and acquires driving information of a plurality of vehicles corresponding to the extended second predetermined period. As a result, since the road surface roughness is evaluated based on more pieces of driving information at locations where the road surface roughness has changed more than expected, which can improve the evaluation accuracy of road surface roughness for road surface change locations. In addition, compared to a case where the evaluation accuracy of the road surface roughness is improved with respect to the entire road, the data amount of the driving information used to evaluate the road surface roughness can be reduced, which reduces the load on the apparatus and communication infrastructure. Therefore, the road surface roughness can be efficiently and accurately evaluated.

(2) The longer the interval between the first and second predetermined periods, the larger the predetermined threshold is set. As a result, highly accurate road surface roughness evaluation is limited to road surface change locations that require urgent repair of depression that has occurred or the like, so that road surface change locations due to aging are excluded. As a result, the data amount of the driving information used to evaluate the road surface roughness can be further reduced.

(3) The information acquisition unit 111 acquires the driving information of the plurality of vehicles corresponding to the predetermined period from the memory device 40 that stores the driving information of the plurality of vehicles 20. When the magnitude of the change rate exceeds the predetermined threshold and the roughness value corresponding to the second predetermined period is smaller than the roughness value corresponding to the first predetermined period, the information acquisition unit 111 deletes the driving information corresponding to the first predetermined period from the memory device 40. As a result, the data amount of the driving information stored in the memory device 40 can be reduced.

In the above embodiment, when the information acquisition unit 111 as a driving information acquisition unit estimates that the magnitude of the change rate exceeds the predetermined threshold, it changes the start or end point of the second predetermined period to extend the second predetermined period, and additionally acquires driving information of a plurality of vehicles corresponding to the extended second predetermined period. Then, the evaluation unit 112 as a calculation unit calculates the road surface roughness value corresponding to the second predetermined period using the additionally acquired driving information. However, when the driving information acquisition unit estimates that the magnitude of the change rate exceeds the predetermined threshold, it may additionally acquire the driving information of the plurality of other vehicles 20 corresponding to the second predetermined period in addition to the driving information of the plurality of vehicles 20 corresponding to the second predetermined period.

Further, in the above embodiment, the information acquisition unit 111 as a map information acquisition unit acquires map information including information on the road on which the vehicle 20 is driving from the memory unit 120. However, the map information acquisition unit may acquire map information including information on the road on which the vehicle 20 is driving from an external server device or the like.

The above embodiment can be combined as desired with one or more of the above modifications. The modifications can also be combined with one another.

The present invention allows efficient and accurate evaluation of road surface profiles.

Above, while the present invention has been described with reference to the preferred embodiments thereof, it will be understood, by those skilled in the art, that various changes and modifications may be made thereto without departing from the scope of the appended claims.

What is claimed is:

1. A road surface evaluation apparatus comprising
a microprocessor and a memory connected to the microprocessor, wherein
the microprocessor is configured to perform:
acquiring driving information of each of a plurality of vehicles, including acceleration information indicating acceleration of each of the plurality of vehicles and map information including information of a road where the plurality of vehicles have driven;
calculating a roughness value indicating a roughness of surface of the road corresponding to a predetermined period based on the driving information of the plurality of vehicles driving on the road during the predetermined period; and
outputting roughness information including the roughness value in association with the information of the road included in the map information, wherein
the microprocessor is configured to perform
the acquiring including, in a case where calculating the roughness value corresponding to a second predetermined period after a first predetermined period, estimating whether or not a magnitude of a change rate of the roughness value corresponding to the second predetermined period with respect to the roughness value corresponding to the first predetermined period exceeds a predetermined threshold to acquire, in a case where the magnitude of the change rate is estimated to exceed the predetermined threshold, more pieces of the driving information to be used for calculating the roughness value corresponding to the second predetermined period than in a case where the magnitude of the change rate is estimated to be equal to or less than the predetermined threshold.

2. The road surface evaluation apparatus according to claim 1, wherein
the microprocessor is configured to perform
the acquiring including, in case where the magnitude of the change rate is estimated to exceed the predetermined threshold, changing a start point of the second predetermined period to extend the second predetermined period, and acquiring the driving information of the plurality of vehicles corresponding to the second predetermined period after extension.

3. The road surface evaluation apparatus according to claim 1, wherein
the microprocessor is configured to perform
the acquiring including, in case where the magnitude of the change rate is estimated to exceed the predetermined threshold, changing an end point of the second predetermined period to extend the second predetermined period, and acquiring the driving information of the plurality of vehicles corresponding to the second predetermined period after extension.

4. The road surface evaluation apparatus according to claim 1, wherein
the microprocessor is configured to perform
the acquiring including, in case where the magnitude of the change rate is estimated to exceed the predetermined threshold, acquiring the driving information of a vehicle other than the plurality of vehicles corresponding to the second predetermined period in addition to the driving information of the plurality of vehicles corresponding to the second predetermined period.

5. The road surface evaluation apparatus according to claim 1, wherein
the longer an interval between the first predetermined period and the second predetermined period, the larger the predetermined threshold is set.

6. The road surface evaluation apparatus according to claim 1, wherein
the memory stores the driving information of the plurality of vehicles corresponding to each of the first predetermined period and the second predetermined period, and
the microprocessor is configured to further perform
in a case where the magnitude of the change rate exceeds the predetermined threshold and the roughness value corresponding to the second predetermined period is smaller than the roughness value corresponding to the first predetermined period, deleting the driving information corresponding to the first predetermined period from the memory.

7. The road surface evaluation apparatus according to claim 1, wherein
the microprocessor is configured to further perform
determining whether or not there is a road surface change point where the magnitude of the change rate exceeds the predetermined threshold on the road, and
the microprocessor is configured to perform
the acquiring including acquiring, in case where there is the road surface change point on the road, more pieces of the driving information to be used for calculating the roughness value of the road surface change point corresponding to the second predetermined period than a point where the magnitude of the change rate is equal to or less than the predetermined threshold.

8. The road surface evaluation apparatus according to claim 7, wherein
the memory stores the driving information of the plurality of vehicles corresponding to each of the first predetermined period and the second predetermined period, and
the microprocessor is configured to further perform
in a case where the roughness value corresponding to the second predetermined period is smaller than the roughness value corresponding to the first predetermined period, deleting the driving information corresponding to the road surface change point from the memory.
